(19) United States
(12) Patent Application Publication
(10) Pub. No.: US 2025/0102319 A1
(43) Pub. Date: Mar. 27, 2025

(54) SIMILARITY CALCULATION METHOD CONSIDERING MULTIPLE FEATURES FOR MULTI-SCALE ROAD NETWORK

(71) Applicant: LANZHOU JIAOTONG UNIVERSITY, Lanzhou (CN)

(72) Inventors: Xiaomin LU, Lanzhou (CN); Haowen YAN, Lanzhou (CN); Weifang YANG, Lanzhou (CN); Wende LI, Lanzhou (CN); Jingzhong LI, Lanzhou (CN); Tao LIU, Lanzhou (CN)

(21) Appl. No.: 18/812,975

(22) Filed: Aug. 22, 2024

(30) Foreign Application Priority Data
Sep. 22, 2023 (CN) 202311235494.7

(51) Int. Cl. G01C 21/00

(52) U.S. Cl. CPC G01C 21/3867

(57) ABSTRACT

Disclosed in the present disclosure is a similarity calculation method considering multiple features for a multi-scale road network, which includes structural similarity calculation of skeleton lines and local feature similarity calculation of the multi-scale road network. A road network stroke is generated, skeleton lines of the road network are extracted and transformed into a structure tree, and the skeleton similarity of the road network is evaluated by calculating structural similarity of the structure tree of the multi-scale road network. Topological similarity of the multi-scale road network is calculated by using a difference matrix of a conceptual domain graph of road meshes, geometric similarity of the multi-scale road network is calculated by using a density of road meshes, and local similarity of the multi-scale road network is obtained by integrating the hierarchy of the road network into the topological and geometric similarity calculation in the form of matrices.

### TECHNICAL FIELD

The present disclosure relates to the field of cartographic generalization of maps, and in particular to a spatial similarity calculation method considering road network skeleton lines and local hierarchy multi-features and used in a multi-scale road network generalization process.

### BACKGROUND

A spatial similarity relationship belongs to the category of a spatial relationship, which is used for describing and expressing the relationship between a geographical space and a map spatial object transformed from the geographical space. The spatial similarity relationship is widely used in describing and matching spatial objects, querying and updating spatial databases, and spatial cognition and reasoning. As an important geographical element, a road network is related to every aspect of people's daily life, and also affects many fields such as politics, economy and military of the country. Multi-scale spatial similarity research has been widely applied in a cartographic generalization process and the aspects of result evaluation, spatial query, road network matching, etc.

Traditional calculation methods for road network spatial similarity focus on topology, geometry and shape features respectively, but they do not measure the similarity from the whole. The existing similarity calculation methods can't integrate semantic information well. According to the Gestalt psychology principle, when we perform spatial cognition, the approximate structure and hierarchy of things will be formed in advance in our mind. The description of road network skeleton line features is conducive to reflecting the structural features of a road network as a whole. Therefore, in the process of road network similarity determination, firstly, starting from the overall features of the road network, more attention is paid to the skeleton structure of the road network; and secondly, attention is paid to local detail features, and semantic information in the local detail features can also reflect relative importance of road sections. Therefore, it is necessary to extend the existing similarity calculation methods according to the features of the road network in order to realize the reasonable calculation of spatial similarity of the multi-scale road network.

Based on the above reasons, the present disclosure provides a multi-feature road network spatial similarity calculation method considering road network skeleton lines and local levels, which aims at providing a more reasonable and perfect multi-scale road network similarity calculation model.

### SUMMARY

The present disclosure provides a similarity calculation method considering multiple features for a multi-scale road network, and calculation is performed from two basic units, namely road network skeleton lines and road meshes. Factors considered in the method are more in line with the actual change condition of a spatial relationship in a road network scale transformation process, and a spatial similarity calculation model of the multi-scale road network can be more reasonable and perfect.

Multi-scale road network similarity research plays a very critical role in the related fields. Gestalt psychology research shows that skeleton line features are usually considered first, and then local detail features are considered in the process of spatial similarity calculation. The road hierarchy is important semantic information of the road network, which can reflect the relative importance degree of road sections. Therefore, the present disclosure provides a method for calculating similarity of a multi-scale road network step by step from integral skeleton lines to local details. Firstly, the skeleton lines of the road network are extracted according to a length threshold, then the skeleton lines are converted into a structure tree, and the structural similarity is calculated on the basis of the structure tree. Secondly, local similarity of the multi-scale road network is calculated by combining topological similarity, geometric similarity and semantic features of road meshes.

The similarity calculation method considering multiple features for a multi-scale road network disclosed by the present disclosure is easy to realize, simple and efficient. A similarity calculation model of the multi-scale road network is perfected, moreover, a similarity experiment calculation result accords with the actual ground feature change condition, and relatively high consistency with a human cognition result is achieved.

### BRIEF DESCRIPTION OF THE DRAWINGS

In order to more clearly describe the technical solutions in the present disclosure or the prior art, a brief introduction to the accompanying drawings required for the description of the examples or the prior art will be provided below. Obviously, the accompanying drawings in the following description are merely some accompanying drawings of the present disclosure. Those of ordinary skill in the art can also derive other accompanying drawings from these accompanying drawings without making creative efforts.

FIG. 1 is a spatial similarity calculation model for a multi-scale road network of the present disclosure.

FIG. 2 is a schematic structural diagram of a road skeleton of the present disclosure.

FIG. 3 is a schematic diagram of road meshes of the present disclosure.

FIG. 4A is a schematic diagram of a matching principle of road meshes before scale transformation of the present disclosure.

FIG. 4B is a schematic diagram of a matching principle of road meshes after scale transformation of the present disclosure.

FIG. 5A is a road network of a schematic change diagram of a 1:25,000 multi-scale road network.

FIG. 5B is a road network of a schematic change diagram of a 1:50,000 multi-scale road network.

FIG. 5C is a road network of a schematic change diagram of a 1:100,000 multi-scale road network.

FIG. 5D is a road network of a schematic change diagram of a 1:250,000 multi-scale road network.

FIG. 6A is a schematic diagram of skeleton lines of a 1:25,000 multi-scale road network.

FIG. 6B is a schematic diagram of skeleton lines of a 1:50,000 multi-scale road network.

FIG. 6C is a schematic diagram of skeleton lines of a 1:100,000 multi-scale road network.

FIG. 6D is a schematic diagram of skeleton lines of a 1:250,000 multi-scale road network.

FIG. 7 shows a similarity sequence diagram of a density of meshes.

FIG. 8 shows a similarity sequence diagram of a hierarchy of meshes.

### DETAILED DESCRIPTION OF THE EMBODIMENTS

The technical solutions in the examples of the present disclosure will be clearly and completely described below with reference to the accompanying drawings in the examples of the present disclosure. Obviously, the described examples are merely some examples rather than all examples of the present disclosure. All the other examples obtained by those of ordinary skill in the art based on the examples in the present disclosure without creative efforts shall fall within the scope of protection of the present disclosure.

The calculation steps for skeleton line similarity of the multi-scale road network are as follows:

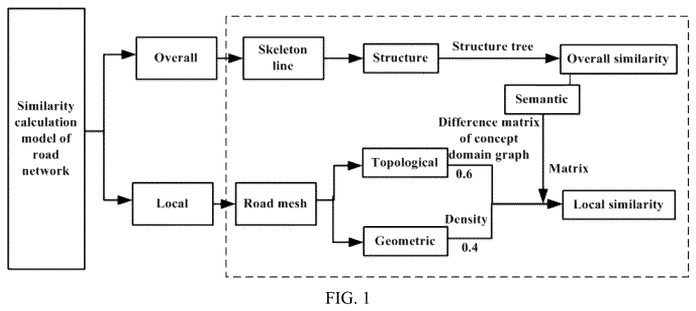

FIG. 1 shows an overall flow of the method provided by the present disclosure, which includes two parts of skeleton line similarity calculation of the multi-scale road network and local similarity calculation of the multi-scale road network.

The following steps are part of skeleton line similarity calculation of multi-scale road network:

Step 1: Performing scale transformation on the road network m times. Firstly, connecting road sections with the same name first, and then performing stroke construction on the road network to generate n road strokes. Secondly, determining the number of roads selected in the road network scale transformation by using a root model shown in Formula 1, and then performing selection according to lengths of the roads, where the shorter ones are preferentially deleted:

$${n}_{F} = {n}_{A} \sqrt{\frac{{M}_{A}}{{M}_{F}}} . \qquad ( 1 )$$

In the formula, n_{F} represents the total number of elements in a new map, n_{A} represents the total number of elements in an original map, M_{A} represents a scale denominator of the original map, and M_{F} represents a scale denominator of the new map.

Step 2: setting thresholds according to the lengths of the roads and functional network indexes to extract skeleton lines of the roads. A specific process is as follows:

1) Connecting the road sections with the same name according to the road section names, and connecting the remaining road sections according to geometric features to construct strokes.

2) Sorting the successfully constructed strokes of the network according to the length.

3) Performing functional network analysis on the road network by using space syntax, and calculating an importance value of each stroke according to a connection value, a control value, a local integration degree and an overall depth value.

4) Calculating an adjustment coefficient λ as a threshold for skeleton line extraction according to a length mean value and a standard deviation as shown in Formula 2:

$$λ = \frac{Mean\_length ( stroke )}{Std\_length ( stroke )} . \qquad ( 2 )$$

In the formula, the adjustment coefficient λ is used for adjusting the number of skeleton roads selected, Mean_length(stroke) represents a length mean value of the stroke, Std_length(stroke) represents a standard deviation of the stroke, and μ represents the proportion of the actual skeleton road as shown in Formula 3:

$$μ = \{ \begin{matrix}1 \times 0.44 , & λ \leq 1 \\ λ \times 0.44 , & 1 < λ < 2.27 \\ 1 , & λ \geq 2.27\end{matrix} . \qquad ( 3 )$$

5) Calculating a mileage proportion a of the skeleton road as shown in Formula 4:

$$a = μ * L . \qquad ( 4 )$$

In the formula, L represents the total length value of road network data.

6) Calculating theoretical proportions and theoretical mileage values of a contour skeleton and a functional skeleton in the total mileage respectively, where the proportion of the contour skeleton calculated according to the length is 0.6a, and the proportion of the functional skeleton calculated according to the importance value is 0.4a.

7) Calculating the number of the skeleton lines according to the theoretical proportions and the theoretical mileage values.

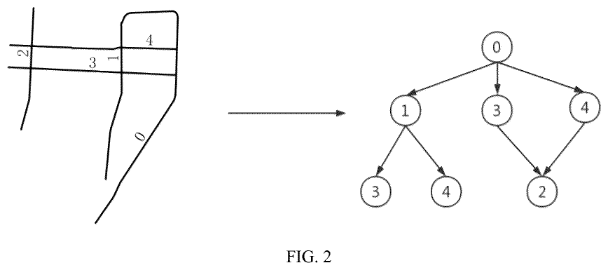

Step 3: According to the connection transformation principle in FIG. 2, first transforming each road into a node of the structure tree and selecting the longest road as the parent node of the structure tree, and then connecting the nodes in turn according to the connection relationship between the roads to form the structure tree.

Step 4: Calculating the similarity of the child nodes of the structure tree by using Formula 5 and Formula 6:

$$S ( n 1 , n 2 ) = S\_offsping ( n 1 , n 2 ) + S\_sunnum ( n 1 , n 2 ) + S\_height ( n 1 , n 2 ) \qquad ( 5 )$$

In the formula, S(n1,n2) represents the similarity of nodes n1 and n2, and S_offspring, S_sunnum and S_height represent the similarity of the number of offspring, the similarity of the number of sons, and the similarity of heights of offspring respectively.

$$S\_sunnum ( n 1 , n 2 ) = {R}_{1} \times \frac{min ( {n}_{1} \_sun , {n}_{2} \_ sun )}{max ( {n}_{1} \_ sun , {n}_{2} \_ sun )} + {R}_{2} \times \frac{min ( {n}_{1} \_sun , {n}_{2} \_ sun )}{max ( Brother )} \qquad ( 6 )$$

In the formula, R₁, R₂ represent coefficients for adjusting the proportions of the absolute similarity and the relative similarity, which are both set to 0.5, min(n₁_sun, n₂_sun) represents the one with the smaller number of sons in node n1 and node n2, max(Brother) represents the one with the smaller number of the largest number max(Brother1) of sons in brother node of node n1 and the largest number max(Brother2) of sons in brother node of node n2. The calculation formulas of the similarity S_offspring of the number of offspring and the similarity S_height of heights of offspring are consistent with the above formula in thinking.

The similarity of child nodes in the two trees is calculated by using the above formulas. The greater the similarity, the greater the probability that the two nodes are the same node, that is, the greater the probability that the roads are the same road at two scales. The smaller the similarity, the greater the probability that the two nodes are mismatched nodes, indicating that the road is deleted during scale transformation.

Step 5: Finding out the matched nodes according to the similarity of the nodes mentioned above, and calculating structural similarity of the nodes by using Formula 7 and Formula 8:

$$Sim\_global = 1 - {\sum }_{i = 1}^{m} ( ( D - value ) * {( \frac{1}{r} )}^{l a y e r ( {n}_{i} )} ) , and \qquad ( 7 )$$

$$D - value = {R}_{1} \times \vert n 1 \_sumnum - n 2 \_sumnum \vert + {R}_{2} \times \vert n1\_height - n 2 \_height \vert + {R}_{3} \times \vert \sqrt{n1\_offspring} - \sqrt{n2\_offspring} \vert . \qquad ( 8 )$$

In the formulas, Sim_global represents the structural similarity of two structure trees, m represents the total number of the same node, 1/r represents a hierarchical penalty coefficient, layer (nᵢ) represents the number of layers of the node, R₁, R₂ and R₃ represent weights of the number of sons of the node, the height of the node, and the number of offspring of the node respectively, n1_sumnum and n2_sumnum represent the numbers of sons of nodes n1 and n2 respectively, n1_height and n2_height represent the heights of nodes n1 and n2 respectively, and \sqrt{n1_offspring} and |\sqrt{n2_offspring}| represent the numbers of offspring of nodes n1 and n2 respectively. The greater Sim_global, the greater the similarity of the two trees, indicating that the more similar the structures of skeleton lines of the road networks at two scales.

The calculation steps for local similarity of the multi-scale road network are as follows:

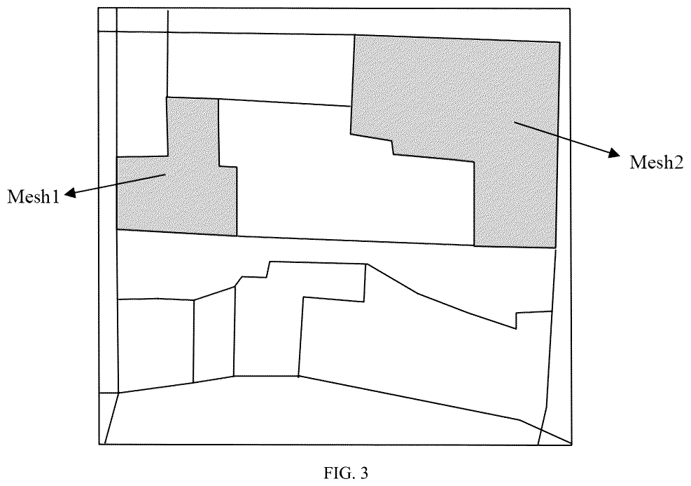

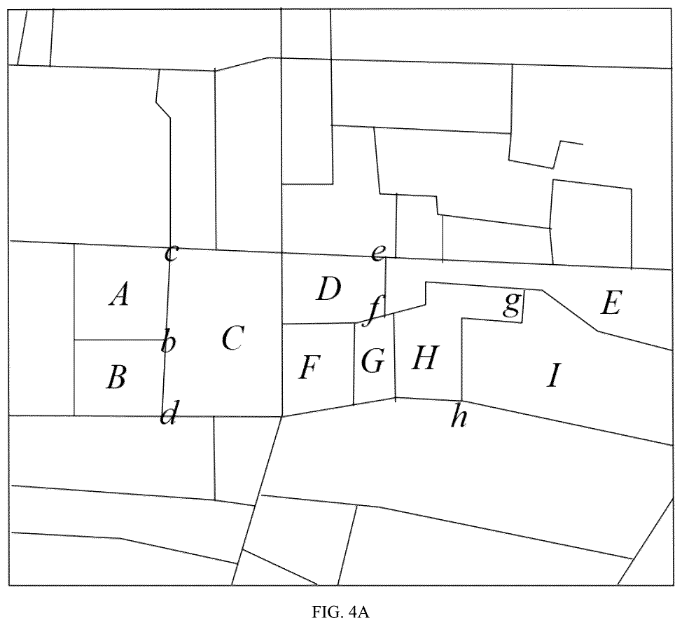

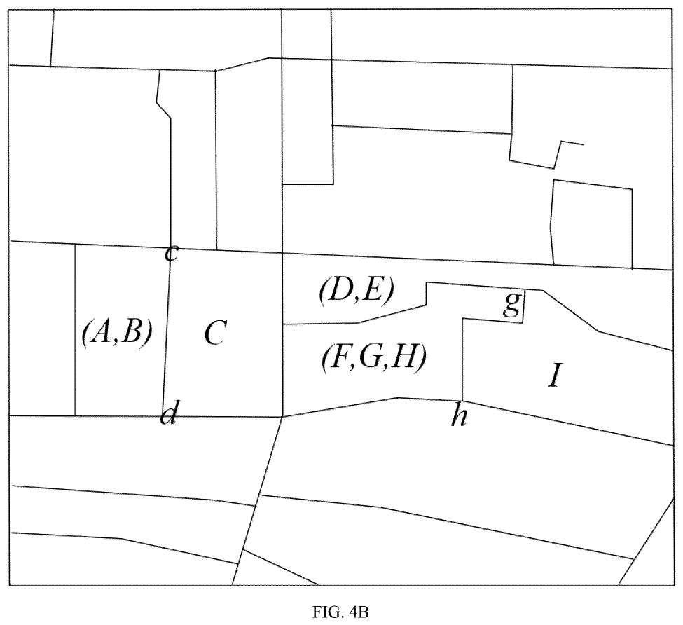

Step 6: The smallest closed loops naturally formed by several road sections in the road network are called road meshes, as shown in FIG. 3. According to the thinking of the difference matrix of the conceptual domain graph, perform topological quantization on topological values of the road meshes according to the dimensions of connected components. The connection dimension of separation is 0, the connection dimension of a point connection is 1, and the connection dimension of a line connection is 2. According to FIG. 4A and FIG. 4B, calculate the topological quantization values of the road mesh at the same position at two scales, as shown in Formula 9:

$${V}_{i} = {\sum }_{i = 0}^{m} {n}_{i} . \qquad ( 9 )$$

In the formula, m represents the number of other road meshes that have a topological relationship with the road mesh T, and nᵢ represents the connection dimension of all topological relationships.

Step 7: Acquiring the topology difference of each road mesh before and after scale transformation, as shown in Formula 10:

$${T}_{i} = \frac{\vert {V}_{1} - {V}_{2} \vert}{max ( {V}_{1} , {V}_{2} )} . \qquad ( 10 )$$

In the formula, V₁ and V₂ represent topological quantization values of the road mesh before and after scale transformation respectively, and max(V₁, V₂) represents the larger one of the two topological quantization values. Finally, acquiring topological similarity of the multi-scale road network by using Formula 11:

$$Sim\_T = 1 - \frac{{\sum }_{i = 0}^{n} {T}_{i}}{{n}^{{}_{2}}} . \qquad ( 11 )$$

In the formula, n represents the number of the road meshes.

Step 8: Matching all the scaled road networks with the original road network, and then, calculating a density of each mesh according to Formula 12.

$$G = \frac{P + L}{A} \qquad ( 12 )$$

In the formula, P represents the total length of the road sections on the boundary of the mesh, L represents the total length of the road sections within the mesh, and A represents a mesh area.

Step 9: Calculating geometric similarity of two groups of road network targets, firstly, calculating a density difference of each pair of road meshes before and after scale transformation by using Formula 13, and generating a one-dimensional array.

$$Sim\_G = \frac{\vert {G}_{1} - {G}_{2} \vert}{max ( {G}_{1} , {G}_{2} )} \qquad ( 13 )$$

In the formula, G₁ and G₂ represent geometric eigenvalues before and after scale transformation, i.e. a density, and max(G₁, G₂) represents the larger one of the two geometric eigenvalues. The calculated similarity values of all the mesh densities generate an array: S={S₁, S₂, . . . , Sₙ}, where Sₙ represents the density similarity of the nth pair of road meshes in the scale transformation, and n represents the total number of road meshes in the road network target. Finally, calculate the geometric similarity Sim_C of the road network before and after the scale transformation by using Formula 14.

$$Sim\_C = 1 - \frac{\sum S}{n} . \qquad ( 14 )$$

Step 10: Getting the importance hierarchy of each road mesh by using Formula 15:

$${D}_{i} = {d}_{1} * \frac{l 1}{{\sum }_{i = 0}^{n} {l}_{i}} + {d}_{2} * \frac{l 2}{{\sum }_{i = 0}^{n} {l}_{i}} + … + {d}_{n} * \frac{ln}{{\sum }_{i = 0}^{n} {l}_{i}} . \qquad ( 15 )$$

In the formula, Dᵢ represents the hierarchy size of each road mesh, and according to human cognition, the longer the length of the road on a peripheral of the mesh, the greater the degree of influence on the hierarchy of the road mesh, such that the hierarchy of the road mesh is positively correlated with the length of the peripheral road. dᵢ represents the hierarchy of each road constituting the periphery of the road mesh, and li represents the length of each road constituting the periphery of the road mesh.

Step 11: Combining the hierarchy of the road mesh with topological and geometric feature similarity, and acquiring a local similarity calculation model considering semantic information of the road network in the form of a matrix, as shown in Formula 16:

$$Sim\_local = 1 - \frac{\begin{matrix}[ {D}_{1} & {D}_{2} & … & {D}_{i} ]\end{matrix} \cdot [ \begin{matrix}{T}_{1} & {S}_{1} \\ {T}_{2} & {S}_{2} \\ … & … \\ {T}_{i} & {S}_{i}\end{matrix} ] \cdot [ \begin{matrix}{w}_{1} \\ {w}_{2}\end{matrix} ]}{n} . \qquad ( 16 )$$

In the formula, w₁ and w₂ represent weights of the topological similarity and the geometric similarity of the road mesh respectively. Existing studies show that topological features can better grasp the essence of spatial distribution, and the weights are set to 0.6 and 0.4 respectively.

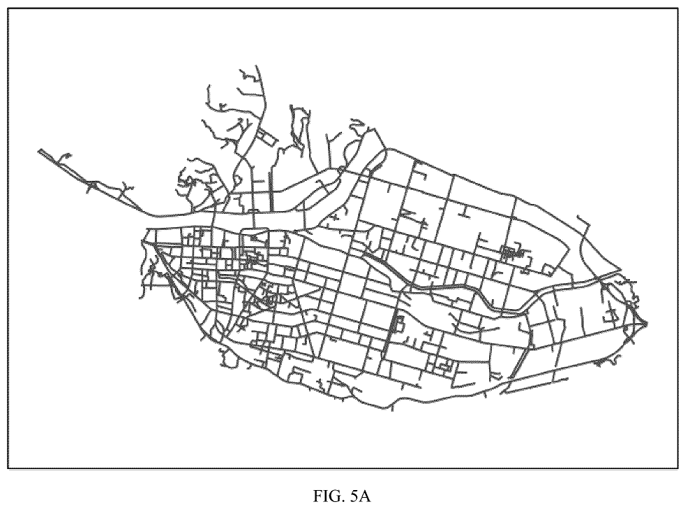

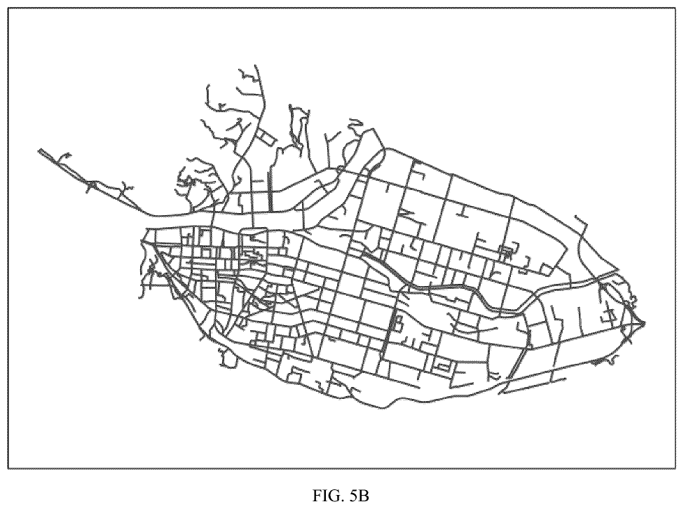

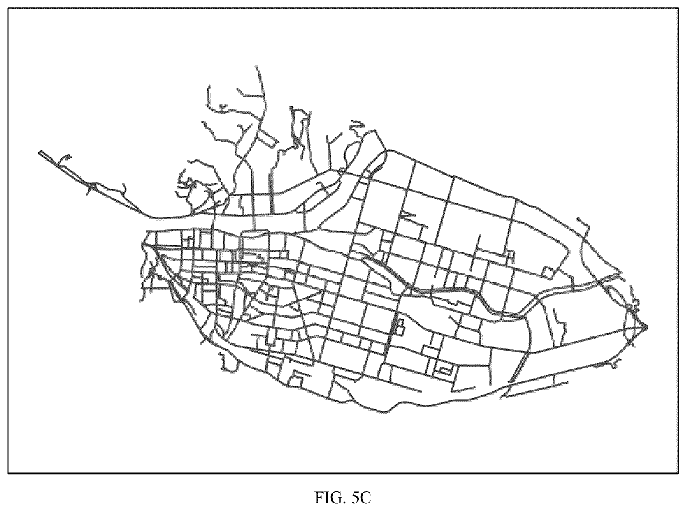

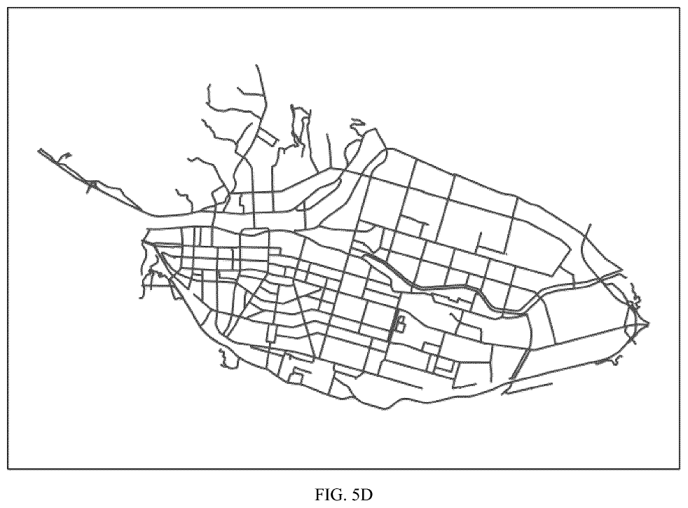

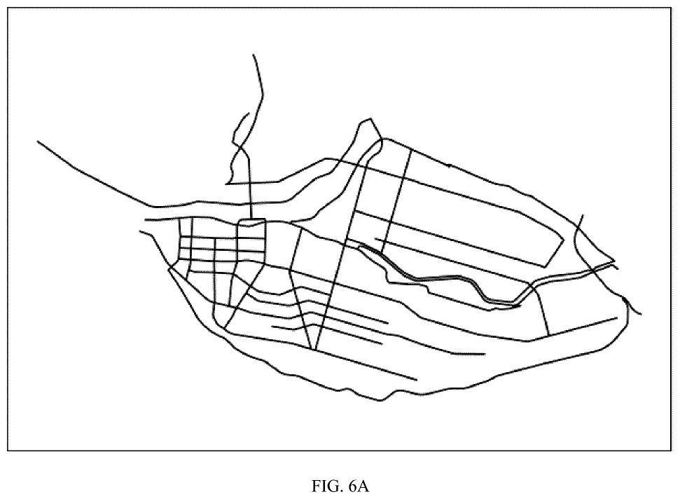

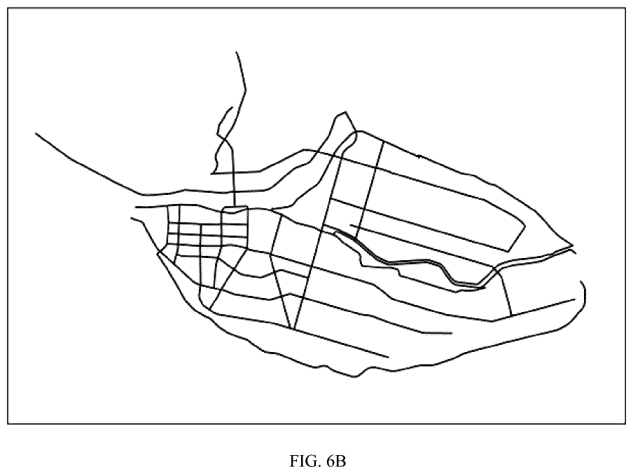

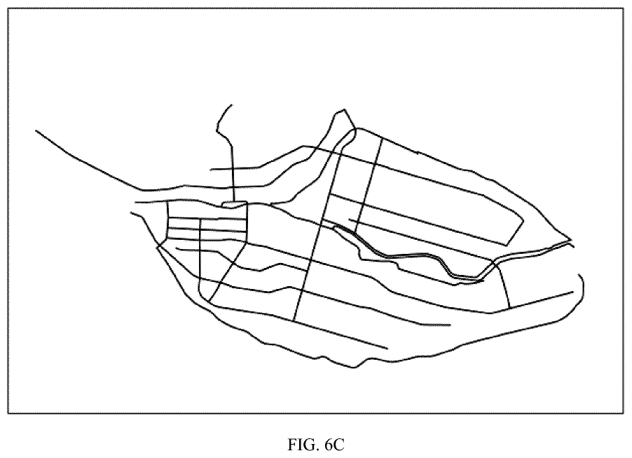

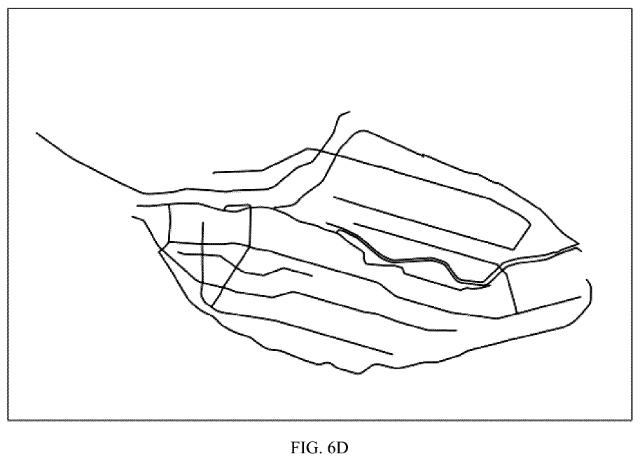

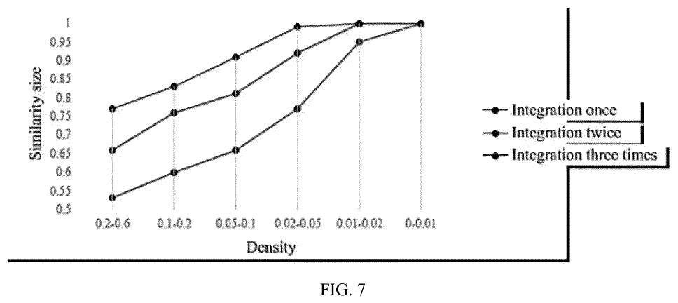

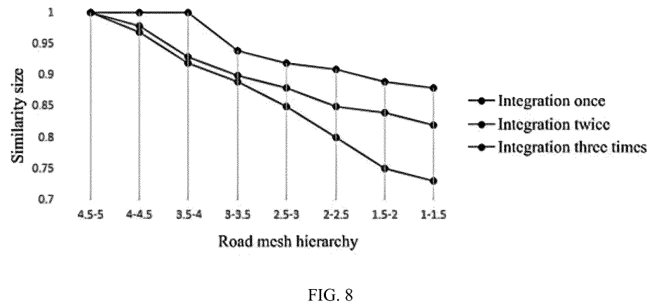

Step 12: An example of calculating the spatial similarity of the multi-scale road network is given below. Results before and after the scale transformation of the road network are shown in FIG. 5A, FIG. 5B, FIG. 5C and FIG. 5D and the skeleton lines of the road network are shown in FIG. 6A, FIG. 6B, FIG. 6C and FIG. 6D. In order to further analyze the role of the local density retention degree and the road hierarchy in similarity calculation in local features, the density of the road mesh and the road mesh hierarchy are divided into 8 sections and 6 sections respectively, and the average density similarity and average overall local similarity of the road mesh in each section are calculated. The results are shown in FIG. 7 and FIG. 8. In order to verify experimental results, a contrast experiment and a psychological cognition experiment are conducted for this purpose. The contrast experiment employs traditional methods to calculate local similarity based on lines. The survey population of the psychological cognition experiment is divided into map-related professionals and non-map-related professionals. The experimental results are shown in Table 1, the comparative test results are shown in Table 2, and the psychological cognition test results are shown in Tables 3 and 4 respectively.

The experiments and psychological questionnaire survey show that the results of similarity calculation in this description are consistent with the changes of actual geographical elements, which is consistent with human cognition.

TABLE 1
Similarity calculation results

| Similarity | 1:2.5-1:5 | 1:2.5-1:10 | 1:2.5-1:25 |
|---|---|---|---|
| Overall skeleton line | 0.96 | 0.82 | 0.70 |
| Topological | 0.82 | 0.71 | 0.57 |
| Geometric | 0.98 | 0.95 | 0.87 |
| Local (without considering | 0.89 | 0.81 | 0.69 |
| semantic information) | | | |
| Local (considering | 0.91 | 0.84 | 0.75 |
| semantic information) | | | |

TABLE 2
Results of contrast experiment

| Similarity | 1:2.5-1:5 | 1:2.5-1:10 | 1:2.5-1:25 |
|---|---|---|---|
| Overall skeleton line | 0.96 | 0.82 | 0.70 |
| Topological | 0.67 | 0.42 | 0.28 |
| Geometric | 0.90 | 0.84 | 0.76 |
| Local | 0.76 | 0.60 | 0.47 |

TABLE 3
Table of similarity cognition results of non-professionals

| | Overall(%) | | | Local (%) | | |
|---|---|---|---|---|---|---|
| Similarity | 1:2.5-1:5 | 1:2.5-1:10 | 1:2.5-1:25 | 1:2.5-1:5 | 1:2.5-1:10 | 1:2.5-1:25 |
| 90%~100% | 36.50 | 26.50 | 23.00 | 39.13 | 24.35 | 8.70 |
| 80%~90% | 31.00 | 30.50 | 25.52 | 30.43 | 32.17 | 23.04 |
| 70%~80% | 20.50 | 33.50 | 34.00 | 21.74 | 30.44 | 37.83 |
| 60%~70% | 7.10 | 5.20 | 9.80 | 4.56 | 8.03 | 21.74 |
| 50%~60% | 4.90 | 4.30 | 7.68 | 4.14 | 5.01 | 8.69 |

TABLE 4
Table of similarity cognition results of professionals

| | Overall(%) | | | Local (%) | | |
|---|---|---|---|---|---|---|
| Similarity | 1:2.5-1:5 | 1:2.5-1:10 | 1:2.5-1:25 | 1:2.5-1:5 | 1:2.5-1:10 | 1:2.5-1:25 |
| 90%~100% | 45.36 | 32.86 | 26.07 | 43.14 | 17.84 | 5.88 |
| 80%~90% | 31.43 | 42.14 | 19.64 | 33.33 | 44.90 | 16.69 |
| 70%~80% | 16.43 | 17.84 | 40.00 | 13.73 | 27.46 | 42.14 |
| 60%~70% | 3.89 | 4.07 | 8.24 | 7.84 | 5.88 | 23.53 |
| 50%~60% | 2.98 | 3.07 | 6.05 | 1.96 | 3.92 | 11.76 |

The above description of the disclosed examples enables professionals skilled in the art to achieve or use the present disclosure. Various modifications to these examples are readily apparent to professionals skilled in the art, and the general principles defined herein may be implemented in other examples without departing from the spirit or scope of the present disclosure. Therefore, the present disclosure is not limited to the examples shown herein but falls within the widest scope consistent with the principles and novel features disclosed herein.

What is claimed is:

1. A similarity calculation method considering multiple features for a multi-scale road network, comprising two parts of skeleton line similarity calculation of the multi-scale road network and local similarity calculation of the multi-scale road network, wherein
calculation steps for skeleton line similarity of the multi-scale road network are as follows:
S1: connecting road sections with the same name first, and then performing stroke construction on the road network to generate n road strokes;
S2: performing scale transformation on an obtained road network map;
S3: setting thresholds according to lengths of roads and functional network indexes to extract skeleton lines of the roads;
1) sorting the successfully constructed strokes of the multi-scale road network according to the length;
2) performing functional network analysis on the road network by using space syntax, and calculating an importance value of each stroke according to a connection value, a control value, a local integration degree and an overall depth value;
3) calculating an adjustment coefficient as a threshold for skeleton line extraction by using formula
$$λ = \frac{Mean\_length ( stroke )}{Std\_length ( stroke )}$$
to adjust the number of skeleton roads selected, wherein Mean_length(stroke) represents a length mean value of the stroke, and Std_length(stroke) represents a standard deviation of the stroke;
4) calculating a mileage proportion occupied by the skeleton roads by using formula a=μ*L, wherein L represents the total length value of roads, μ represents the proportion occupied by actual skeleton roads, and
$$μ = \{ \begin{matrix}1 \times 0.44 & , & λ \leq 1 \\ λ \times 0.44 & , & 1 < λ < 2.27 \\ 1 & , & λ \geq 2.27\end{matrix} ;$$
5) calculating theoretical proportions and theoretical mileage values of a contour skeleton and a functional skeleton in the total mileage respectively, wherein the proportion of the contour skeleton calculated according to the length is 0.6a, and the proportion of the functional skeleton calculated according to the importance value is 0.4a;
6) calculating the number of the skeleton lines according to the theoretical proportions and the theoretical mileage values;
7) connecting nodes sequentially according to the connection relations between the road skeleton lines to form a skeleton line structure tree;
S4: calculating the similarity S(n1,n2) of the child nodes of the structure tree, and finding out all the successfully matched nodes accordingly, wherein:
S(n1,n2)=S_offspring (n1,n2)+S_sunmim(n1,n2)+S_height(n1,n2), in the formula, S(n1,n2) represents the similarity of nodes n1 and n2, and S_offspring, S_sunmum and S_height represent the similarity of the number of offspring, the similarity of the number of sons, and the similarity of heights of offspring respectively;
calculating the similarity of the number of sons by using the formula
$$S\_sunnum ( n 1 , n 2 ) = {R}_{1} \times \frac{min ( {n}_{1 -} sun , {n}_{2 -} sun )}{max ( {n}_{1 -} sun , {n}_{2 -} sun )} + {R}_{2} \times \frac{min ( {n}_{1 -} sun , {n}_{2 -} sun )}{min ( max ( Brother ) )} ,$$
wherein R₁, R₂ represent coefficients of proportions of the absolute similarity and the relative similarity, which are both set to 0.5, min(n₁_sun, n₂_sun) represents the one with the smaller number of sons in node n1 and node n2, min(max(Brother)) represents the one with the smaller number of the largest number max(Brother1) of sons in brother node of node n1 and the largest number max(Brother2) of sons in brother node of node n2, and the calculation formulas of the similarity S_offspring the number of offspring and the similarity S_height of heights of offspring are consistent with the above formula in thinking;
S5: accumulating the structural similarity of all successfully matched nodes to obtain the structural similarity Sim_global of the skeleton lines of the road network:
$$Sim\_global = 1 - {\sum }_{i = 1}^{m} ( ( D - value ) * {( \frac{1}{r} )}^{l a y e r ( {n}_{i} )} ) \qquad ( 8 )$$
$$D - value = {R}_{1} \times \vert n 1 \_sumnum - n2\_sumnum \vert + {R}_{2} \times \vert n1\_height - n2\_height \vert + {R}_{3} \times \vert \sqrt{n1\_offspring} - \sqrt{n2\_offspring} \vert ,$$
wherein m represents the total number of the same node, 1/r represents a hierarchical penalty coefficient, layer(nᵢ) represents the number of layers of the node, R₁, R₂ and R₃ represent weights of the number of sons of the node, the height of the node, and the number of offspring of the node respectively, which are all set herein as ⅓, n1_sumnum [symbol] n2_sumnum represent the numbers of sons of nodes n1 [symbol] n2 respectively, n1_height [symbol] n2_height represent the heights of nodes n1, n2, and \sqrt{n1_offspring} and \sqrt{n2_offspring} represent the numbers of offspring of nodes n1, n2;
the calculation steps for local similarity of the multi-scale road network are as follows:
S6: matching all scaled road meshes and the original road meshes respectively;
S7: calculating topological quantization values Vᵢ=Σᵢ₌₀^{m}nᵢ of road meshes at the same of each road mesh, position at two scales and calculating topological differences
$${T}_{i} = \frac{\vert {V}_{1} - {V}_{2} \vert}{max ( {V}_{1} , {V}_{2} )}$$
of each road mesh, wherein m represents the number of other road meshes having a topological relationship with the road mesh T, nᵢ represents a connection dimension of all topological relationships, V₁ and V₂ represent the topological quantization values of the road mesh before and after scale transformation respectively, and max(V₁, V₂) represents the larger one of the two topological quantization values;
S8: acquiring topological similarity
$$Sim\_T = 1 - \frac{{\sum }_{i = 0}^{n} {T}_{i}}{{n}^{2}}$$
of the multi-scale road network according to the topological differences of each road mesh before and after scale transformation, wherein n represents the number of road meshes;
S9: calculating a density
$$G = \frac{P + L}{A}$$
and a density difference
$${S}_{n} = \frac{\vert {G}_{1} - {G}_{2} \vert}{max ( {G}_{1} , {G}_{2} )}$$
of each road mesh at the same position before and after matching, and generating a one-dimensional array S={S₁, S₂, . . . , Sₙ}, wherein P represents the total length of road sections on the mesh boundary, L represents the total length of road sections in the mesh, A represents the mesh area, max(G₁, G₂) represents the larger one of the two geometric eigenvalues, and n represents the total number of road meshes in a road network target;
S10: calculating geometric similarity
$$Sim\_C = 1 - \frac{\sum S}{n}$$
between all scaled roads and original roads;
S11: calculating importance hierarchies
$${D}_{i} = {d}_{1} \times \frac{{l}_{1}}{{\sum }_{i = 0}^{n} {l}_{i}} + {d}_{2} \times \frac{{l}_{2}}{{\sum }_{i = 0}^{n} {l}_{i}} + … + {d}_{n} \times \frac{{l}_{n}}{{\sum }_{i = 0}^{n} {l}_{i}} ,$$
of all the road meshes, wherein, Dᵢ represents the hierarchy size of each road mesh, dᵢ represent the hierarchy of each road constituting the periphery of the road mesh, and lᵢ represents the length of each road constituting the periphery of the road mesh; and
S12: calculating a local similarity calculation result Sim_local: considering semantic information of the road network,
$$Sim\_local = 1 - \frac{\begin{matrix}[ {D}_{1} & {D}_{2} & … & {D}_{i} ]\end{matrix} \cdot [ \begin{matrix}{T}_{1} & {S}_{1} \\ {T}_{2} & {S}_{2} \\ … & … \\ {T}_{i} & {S}_{i}\end{matrix} ] \cdot [ \begin{matrix}{w}_{1} \\ {w}_{2}\end{matrix} ]}{n} .$$
wherein w₁ and w₂ represent weights of the topological similarity and the geometric similarity of the road mesh respectively, which are set to 0.6 and 0.4 respectively herein.
